(19) United States
(12) Patent Application Publication
(10) Pub. No.: US 2010/0174916 A1
(43) Pub. Date: Jul. 8, 2010

(54) Universal File

(75) Inventor: Andrew G. Setos, Pacific Palisades, CA (US)

Correspondence Address: Cantor Colburn LLP - Fox Entertainment Group, 20 Church Street, 22nd Floor, Hartford, CT, 06103, US

(73) Assignee: FOX DIGITAL ENTERPRISES, Los Angeles, CA (US)

(21) Appl. No.: 12/644,163

(22) Filed: Dec. 22, 2009

Related U.S. Application Data
(60) Provisional application No. 61/142,466, filed on Jan. 5, 2009.

(51) Int. Cl. G06F 12/14

(52) U.S. Cl. 713/189

(57) ABSTRACT

A system for processing a universal media file is provided. The system includes a universal file recognition module that processes a universal media file based on a key. A key protection module provides the key based on a business relationship.

### CROSS-REFERENCES TO RELATED APPLICATIONS

This patent application claims priority to U.S. Provisional Patent Application Ser. No. 61/142,466, filed Jan. 5, 2009, which is incorporated herein by reference in its entirety.

### FIELD

The present disclosure relates to a universal media file, and in particular to methods and systems for generating and using the universal media file.

### BACKGROUND

Various media applications exist that can process and present media files to a user. For example, iTunes, Amazon, and Media Player can all accept and play music or video files. However, each media application has its own media file format and methodology for interpreting and presenting the media file. Distributing a media file that can be used by the various media applications presently requires that numerous media files be generated according to the various requirements of the media applications. Such methods of distribution can be memory-intensive, costly, and time-consuming.

### SUMMARY

Accordingly, a system for processing a universal media file is provided. The system includes a universal file recognition module that processes a universal media file based on a key. A key protection module provides the key based on a business relationship.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The drawings described herein are for illustration purposes only and are not intended to limit the scope of the present disclosure in any way. It should be understood that throughout the drawings, corresponding reference numerals indicate like or corresponding parts and features.

FIG. 1 is a block diagram illustrating a computing system that can process a universal media file in accordance with an exemplary embodiment of the present disclosure.

FIG. 2 is a block diagram illustrating the universal media file of FIG. 1 in accordance with an exemplary embodiment of the present disclosure.

FIG. 3 is a dataflow diagram illustrating a media file platform application that includes a universal media file processing module in accordance with an exemplary embodiment of the present disclosure.

FIG. 4 is a flowchart illustrating a universal media file processing method that can be performed by the universal media file processing module of FIG. 3 in accordance with an exemplary embodiment.

FIG. 5 is a flowchart illustrating a universal media file generation method in accordance with an exemplary embodiment.

FIG. 6 is a flowchart illustrating a method of granting access to a universal media in accordance with an exemplary embodiment.

### DETAILED DESCRIPTION

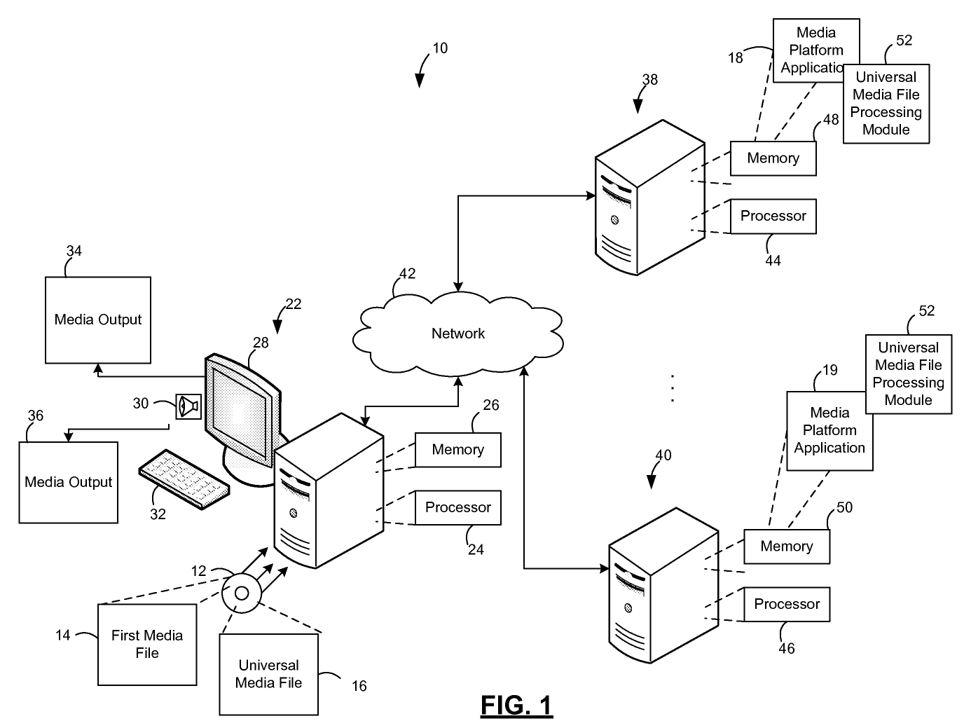

Turning now to the drawings in greater detail, it will be seen that in FIG. 1 an exemplary media system 10 includes a universal media file and a universal media file processing system in accordance with an exemplary embodiment. The media system 10 is merely one example of the various embodiments that can include the universal media file and the universal media file processing system. As can be appreciated, the universal media file can be provided and processed using various media systems and is not limited to the present examples.

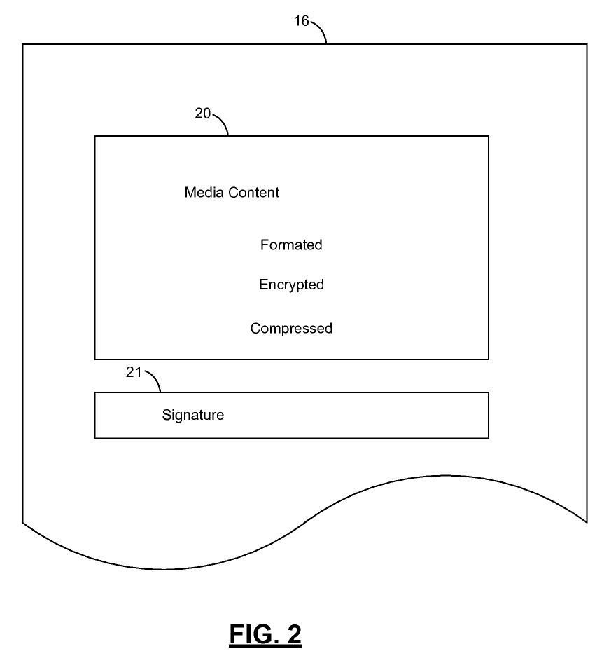

As shown in the example of FIG. 1, a storage medium 12 includes a first media file 14, such as, for example, a music file or a video file, that is recognizable by a first media device (not shown). The first media device can be, for example, a DVD player, a Blu-Ray disc player, an MP3 player, etc. The storage medium 12 additionally or alternatively includes a second media file 16 that is the universal media file 16. The universal media file 16 is recognizable by a plurality of media platform applications 18, 19 other than the first media device. As shown in FIG. 2, the universal media file 16 includes media content 20. The media content 20 is formatted according to a predetermined universal formatting method. The media content 20 is optionally compressed according to a predetermined compression method. The media content 20 is encrypted according to a predetermined encryption method. The universal media file 16 optionally includes a title signature that is used to authenticate the universal media file 16. The title signature can optionally be formatted, compressed, and/or encrypted based on predetermined methods.

With reference back to FIG. 1, the storage medium 12 can be, for example, a physical medium, such as, a CD-ROM, a diskette, a flash drive, or any medium capable of storing media files. In this example, the storage medium 12 is a CD-ROM that can be read by a computer 22; and the universal media file 16 is a digital file that can be accessed by the computer 22. In various other embodiments, the universal media file 16 is stored on central media server (not shown) and accessed via a network 42 in a secured fashion.

The computer 22 includes a processor 24 and memory 26. The processor 24 can be any custom made or commercially available processor, a central processing unit, an auxiliary processor among several processors associated with the computer 22, a semiconductor based microprocessor, a macroprocessor, or generally any device for executing instructions. The memory 26 can be at least one of random access memory, read only memory, a cash, a stack, or the like which may temporarily or permanently store electronic data.

As shown, the computer 22 is associated with a display device 28 and/or an audio device 30, and one or more input devices 32 that may be used by a user to communicate with the computer 22. As can be appreciated, such input devices 32 may include, but are not limited to, a mouse, a keyboard, and a touchpad. The computer 22 is shown to be a desktop computer. As can be appreciated, the computer 22 is not limited to the present example and can include, but is not limited to, a desktop computer, a laptop, a workstation, a portable handheld device, a server, or any device that includes a processor 24 and memory 26.

The processor 24 of the computer 22 executes instructions of one or more of the media platform 18, 19 applications. The media platform applications 18, 19 interpret media files and present the media output 34, 36 to the user via the display device 28, and/or the audio device 30 respectively. The media platform applications 18, 19 can be any media platform application, such as, for example, iTunes, Amazon, Media Player, etc.

In various embodiments, the one or more media platform applications 18, 19 reside on one or more servers 38, 40 and are accessed by the computer 22 via a network 42. The servers 38, 40 similarly include a processor 44, 46 and memory 48, 50; and the media platform applications 18, 19 are stored in the memory 48, 50 respectively. The network 42 can be any single type or combination type of known networks including, but not limited to, a wide area network (WAN), a local area network (LAN), a global network (e.g. Internet), a virtual private network (VPN), and an intranet.

In various other embodiments, the media platform applications 18, 19 are implemented according to a client-server type configuration where, for example, part of the media platform application 18 is stored in the memory 26 of the computer 22 and part of the media platform application 18 is stored in the memory 48 of the server 38. In various other embodiments, the media platform applications 18, 19 reside solely in the memory 26 of the computer 22.

The media platform applications 18, 19 each include a universal media file processing module 52 that recognizes and interprets the universal media file 16 for presentation to the user.

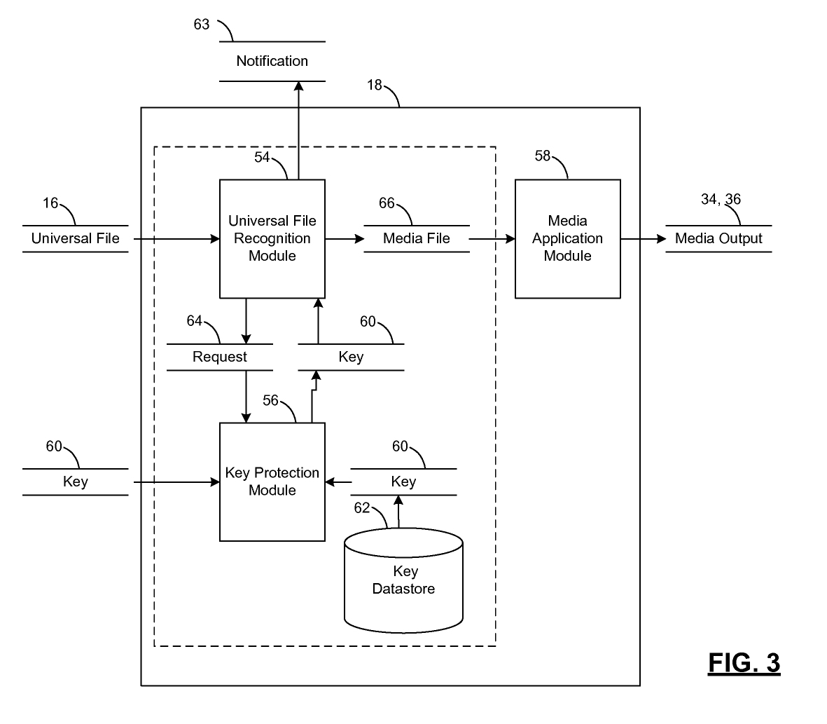

Turning now to FIG. 3, the media platform application 18 that includes the universal media file processing module 52 is shown in more detail in accordance with an exemplary embodiment. In various embodiments, the media platform application 18 and the universal media file processing module 52 include one or more sub-modules and datastores. As can be appreciated, the sub-modules can be implemented as software, hardware, firmware and/or other suitable components that provide the described functionality. As can be appreciated, the sub-modules shown in FIG. 3 can be combined and/or further partitioned to similarly recognize and interpret the universal media file 16 for presentation to the user. In this example, the universal media file processing module 52 includes a universal media file recognition module 54 and a key protection module 56 that communicate with a media application module 58 of the media platform application 18.

The key protection module 56 receives as input a key 60. In one example, the key 60 is an encryption key. In another example, the key 60 is merely an access key. In various embodiments, the key 60 can be associated with a particular type of a media file (e.g., movie files in general, music files in general, a specific movie, a specific type of music, etc), can be associated with a specific universal media file (e.g., the universal media file stored on the CD-ROM), or that is generically associated with universal media files (e.g., a generic universal file encryption key). As will be discussed in more detail below, the key 60 is obtained by the media platform application 18 based on a business relationship.

In various embodiments, the key protection module 56 stores the key 60 in a key datastore 62. When a request 64 to process a universal media file 16 is received, the key protection module 56 retrieves from the key datastore 62 the appropriate key 60 and provides the key 60 to the universal file recognition module 54.

In various other embodiments, the key datastore 62 is maintained outside of the media platform application 18, for example, by a central managing application of the rights to the universal media file 16. In this case, the key protection module merely accesses the key through the network 42 (FIG. 1) based on the business relationship.

The universal file recognition module 54 receives as input the universal media file 16. The universal file recognition module 54 optionally authenticates the universal media file 16 based on the title signature 21 (FIG. 2). In one example, if the title signature 21 (FIG. 2) is not authentic, then the universal file recognition module 54 generates a notification 63 indicating that the universal media file 16 may not be a legitimate file.

When the universal media file 16 is authentic, the universal file recognition module 54 determines a type of the universal media file (for example, based on the title associated with the signature) and initiates the request 64 for the key 60. If the key 60 is provided, the file recognition module 54 decrypts the file based on a predefined decryption method and further based on the key 60 (if it is an encryption key). The universal file recognition module 54 then decompresses the decrypted file based on a predefined decompression method. In various embodiments, the universal file recognition module 54 converts the decompressed file from the universal format to a format of the media platform application 18. The converted file is then provided to the media application module 58 for processing and generating the media output 34, 36. Alternatively, in various embodiments, the media file 66 is provided to the media application module 58 in the universal format for processing and generating the media output 34, 36.

If, however, the key 60 is not provided, the file recognition module 54 generates the notification 63 indicating that the universal media file 16 is not accepted by this media platform application 18.

The media application module 58 receives as input the media file 66 (either in the universal format or in the application format). Based on the format of the media file 66, the media application module 58 processes the content of the media file 66 to produce the media output 34, 36, which is then provided to the user via one or more of the output devices 28, 30 of the computer 22.

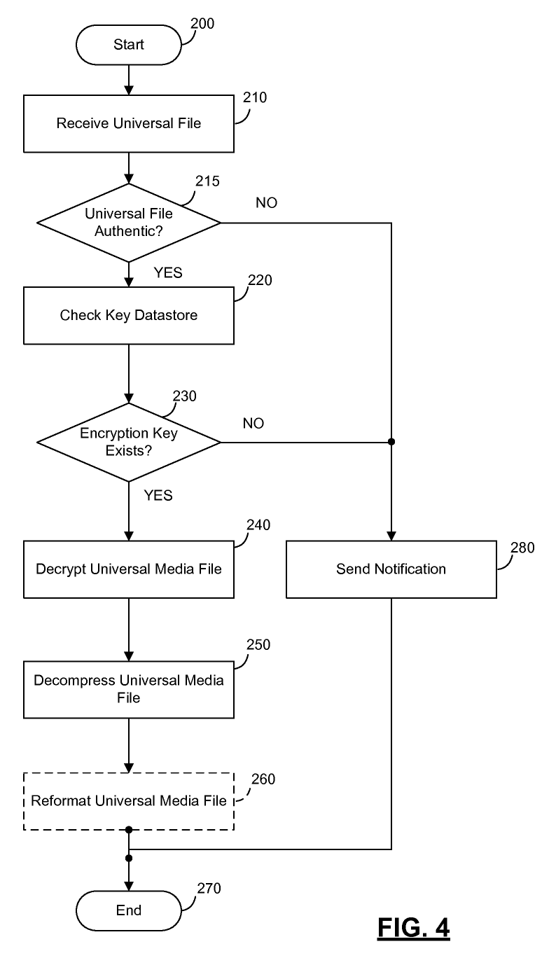

Turning now to FIG. 4, a flowchart illustrates a universal file processing method that can be performed by the universal media file processing module 52 of FIG. 3 in accordance with an exemplary embodiment. As can be appreciated in light of the disclosure, the order of operation within the method is not limited to the sequential execution as illustrated in FIG. 4, but may be performed in one or more varying orders as applicable and in accordance with the present disclosure.

In one example, the method may begin at 200. The universal media file 16 is received at 210. The universal media file 16 is authenticated at 215. If the universal media file 16 is authentic at 215, the key datastore 62 is checked for the appropriate key 60 at 220. If the key 60 is found at 230, the universal media file 16 is decrypted based on the predefined decryption method at 240 and the decrypted file is decompressed based on the predefined decompression method at 250. Optionally, the decompressed file is converted from the universal format to the application format at 260. Thereafter, the method may end at 270.

If, however, at 215, the universal media file 16 is not authentic, the notification 63 is generated at 280, indicating that the universal media file 16 may not be legitimate; and the method may end at 270. If, however, at 230, the key 60 is not found, the notification 63 is presented at 280, indicating that the universal media file 16 is not accepted by this media platform application 18. The method may end at 270.

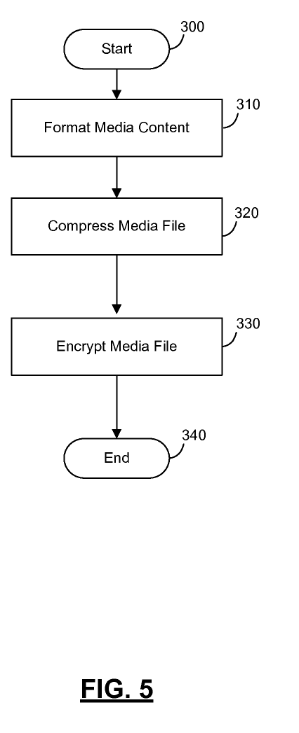

Turning now to FIG. 5, a flowchart illustrates a universal file generation method that can be used to generate the universal media file 16 (FIG. 2) in accordance with an exemplary embodiment. As can be appreciated in light of the disclosure, the order of operation within the method is not limited to the sequential execution as illustrated in FIG. 5, but may be performed in one or more varying orders as applicable and in accordance with the present disclosure.

In one example, the method may begin at 300. The media content 20 is formatted according to the predefined universal formatting standard at 310. The formatted media content is compressed based on the predefined compression method at 320. The compressed media content is then encrypted according to the predefined encryption method at 330. Thereafter, the method may end at 340.

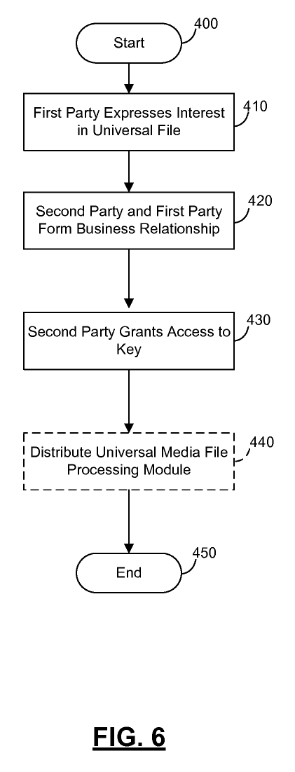

Turning now to FIG. 6, a flowchart illustrates a method of granting access to the universal media file 16 (FIG. 3) in accordance with an exemplary embodiment. As can be appreciated in light of the disclosure, the order of operation within the method is not limited to the sequential execution as illustrated in FIG. 6, but may be performed in one or more varying orders as applicable and in accordance with the present disclosure.

In one example, the method may begin at 400. At 410, a first party associated with the media platform application 18 (FIG. 3) expresses an interest in the universal media file 16 (FIG. 3). The first party develops a business relationship with a second party that owns the rights to the universal media file 16 (FIG. 3) at 420. The second party grants access to the key 60 (FIG. 3) based on the business relationship at 430. Optionally, the second party distributes to the first party the universal media file processing module 52 (FIG. 3) for use by or incorporation into the media platform application 18 (FIG. 3) 440. Alternatively, the formatting, compression, and encryption methods are made publicly known and used by the media platform application 18 (FIG. 3) to process the universal media file 16. Thereafter, the method may end at 450.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Computer program code for carrying out operations of the present invention may be written in any combination of one or more programming languages, including an object oriented programming language such as XML, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A system for processing a universal media file, the system comprising:
a universal file recognition module that processes a universal media file based on a key; and
a key protection module that provides the key based on a business relationship.

2. The system of claim 1 further comprising a media application module that presents the processed universal media file to a user.

3. The system of claim 1 wherein the universal file recognition module processes the universal media file by at least one of decompressing the universal media file, decrypting the universal media file, and reformatting the universal media file.

4. A method of generating a universal media file, the method comprising:
formatting media content based on a universal formatting standard;
compressing the formatted media content based on a predefined compression method; and
encrypting the compressed media content based on a predefined encryption method.

5. A storage medium, the storage medium comprising:
media content that is:
formatted based on a universal formatting standard;
compressed based on a predefined compression method; and
encrypted based on a predefined encryption method.

6. A method of gaining access to a universal file, the method comprising:
establishing a business relationship between a first party that is interested in the universal file and a second party that owns rights to the universal file; and
granting access to a key associated with the universal file to the first party based on the business relationship.

7. The method of claim 6 further comprising distributing a universal file processing module that processes the universal file based on the key to the first party.

8. The method of claim 6 wherein the key is an encryption key.
